(19) United States
(12) Patent Application Publication
(10) Pub. No.: US 2026/0137030 A1
(43) Pub. Date: May 21, 2026

(54) PLANT TIE BAND APPARATUS

(71) Applicant: Padma Agrobotics LLC, Chandler, AZ (US)

(72) Inventors: COLE D. BRAUER, Phoenix, AZ (US); RAGHU NANDIVADA, Chandler, AZ (US); RAJPAL SINGH, Mesa, AZ (US)

(73) Assignee: Padma Agrobotics LLC, Chandler, AZ (US)

(21) Appl. No.: 19/448,804

(22) Filed: Jan. 14, 2026

Related U.S. Application Data
(63) Continuation-in-part of application No. 18/118,033, filed on Mar. 6, 2023.
(60) Provisional application No. 63/321,075, filed on Mar. 17, 2022.

(51) Int. Cl. A01D 59/00; A01D 69/06

(52) U.S. Cl. CPC A01D 59/00; A01D 69/06

(57) ABSTRACT

Systems and apparatus for bundling plants, and more specifically, for automatically tying a plant tie band around a plurality of plants to form a plant bundle, are disclosed herein.

### CROSS REFERENCE TO RELATED APPLICATIONS

This application is a continuation-in-part of, and claims priority to and the benefit of, U.S. Non-Provisional Ser. No. 18/118,033 , filed on Mar. 6, 2023, entitled “Plant Tie Band Apparatus,” and U.S. Provisional Ser. No. 63/321,075, filed on Mar. 17, 2022, entitled “Plant Tie Band Apparatus,” the disclosures of which are incorporated herein by reference in their entireties for all purposes.

### FIELD OF INVENTION

The present disclosure generally relates to systems and apparatus for bundling plants, and more specifically, to systems and apparatus for automatically tying a plant tie band around a plurality of plants to form a plant bundle.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

Many types of crops are commonly bundled for sale or distribution, including herbs and leafy vegetables such as cilantro, coriander, basil, kale, and spinach, as well as root and stem crops such as carrots, green onions, radishes, and beets. The bundling and banding process is traditionally performed by hand, wherein a worker gathers a plurality of plants into a bundle and manually applies a plant tie band or other fastener around the stems to secure the bundle. This manual process can be labor intensive, time consuming, and inconsistent, particularly in large-scale agricultural or packaging operations.

### SUMMARY

Disclosed herein are plant tie band apparatus and plant bundle processing systems. Although described herein in connection with apparatus and systems for tying a tie band around a plant bundle, the present disclosure is not limited thereto. For example, the apparatus and systems disclosed herein may be adapted for securing, bundling, or fastening other items, materials, or structures, and may be implemented in various agricultural, industrial, or packaging applications.

In various embodiments, the plant tie band apparatus may comprise a frame and a main gear. The main gear may define an open portion disposed circumferentially around a plant receiver configured to receive a plant bundle, wherein, in a first position, the open portion is aligned to allow the plant receiver to receive the plant bundle. The main gear may further comprise a receiving arm coupled to the main gear and aligned to receive a tie when the main gear is in a first position. In various embodiments, rotation of the main gear from the first position to a second position may rotate the receiving arm in a substantially circular path around the plant bundle to position the tie for securing the plant bundle.

In various embodiments, the apparatus may further comprise one or more driving gears positioned to engage the main gear and configured to rotate the main gear between the first and second positions. In various embodiments, the one or more driving gears may be driven by a motor.

In various embodiments, the apparatus may further comprise a rotor, the rotor comprising one or more rotor arms configured to engage and twist the tie positioned by the receiving arm to form a tie band around the plant bundle.

In various embodiments, the apparatus may further comprise a tie feeder configured to advance the tie toward the receiving arm when the main gear is in the first position. In various embodiments, the apparatus may further comprise a tie guide positioned along a feed path between the tie feeder and the receiving arm to direct the tie toward the receiving arm. In various embodiments, the apparatus may further comprise a tie cutter configured to sever the tie. In various embodiments, the apparatus may further comprise a plant stem cutter coupled to the frame, the plant stem cutter configured to cut a plurality of plant stems of the plant bundle. In various embodiments, the plant stem cutter may comprise one or more blades positioned beneath the frame.

In various embodiments, the apparatus may further comprise a hub configured to support one or more plant receivers and to rotate the one or more plant receivers between a plurality of stations. In various embodiments, the plurality of stations may comprise a plant receiver station, a tying station at which the main gear is positioned, and an eject station at which the plant bundle is released from the apparatus.

In various embodiments, the open portion of the main gear may comprise from between about 20% and about 50% of a circumference of the main gear.

In various embodiments, the apparatus may further comprise a controller configured to coordinate operation of the main gear.

In various embodiments, the plant tie band apparatus may comprise a main gear defining an open portion disposed circumferentially around a plant receiver configured to receive a plant bundle, the main gear having a receiving arm coupled thereto and configured, in a first position of the main gear, to receive a tie. The apparatus may further comprise a rotor having one or more rotor arms configured to twist the tie positioned by the receiving arm to form a tie band around the plant bundle. The apparatus may further comprise a controller configured to coordinate rotation of the main gear and operation of the rotor. In various embodiments, the controller may be configured to actuate the rotor when the main gear reaches a second position.

In various embodiments, the plant bundle processing system may comprise a plant receiver station configured to receive a plant bundle. The plant bundle processing system may further comprise a tying station comprising a main gear defining an open portion disposed circumferentially around a plant receiver configured to receive the plant bundle. The main gear may further comprise a receiving arm coupled to the main gear and configured, in a first position of the main gear, to receive a tie, and a rotor configured to twist the tie positioned by the receiving arm to form a tie band around the plant bundle. The main gear may further comprise an eject station configured to discharge the plant bundle after formation of the tie band.

In various embodiments, the system may further comprise a sensor positioned at the plant receiver station, wherein the sensor is configured to detect the presence of a plant bundle in the plant receiver station.

In various embodiments, the system may further comprise a plant stem cutter positioned between the tying station and the eject station, the plant stem cutter configured to cut a plurality of plant stems of the plant bundle. In various embodiments, the system may further comprise a controller configured to coordinate operation of at least one of the receiver station, the tying station, the stem cutter, and the eject station.

In various embodiments, the eject station of the system may comprise an eject device configured to assist in removal of the plant bundle from the system, the eject device comprising one or more of an air jet or a mechanical ejector.

### BRIEF DESCRIPTION OF THE DRAWING FIGURES

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an exemplary plant bundle with a tie band configured therearound, in accordance with various embodiments.

FIG. 2 illustrates a schematic view of an exemplary plant tie band apparatus, in accordance with various embodiments.

FIG. 3 illustrates a cross-sectional view of a tie channel in the processing wheel of an exemplary plant tie band apparatus, in accordance with various embodiments.

FIG. 4 illustrates a schematic view of an exemplary plant tie band apparatus, in accordance with various embodiments.

FIG. 5 illustrates a perspective view of an exemplary plant tie band apparatus, in accordance with various embodiments.

FIG. 6 illustrates a perspective view of an exemplary plant tie band apparatus, in accordance with various embodiments.

FIG. 7 illustrates a schematic view of an exemplary plant bundle processing system, in accordance with various embodiments.

FIG. 8 illustrates a front perspective view of an exemplary plant tie band apparatus, in accordance with various embodiments.

FIG. 9 illustrates a side perspective view of an exemplary plant tie band apparatus, in accordance with various embodiments.

FIG. 10 illustrates a top perspective view of an exemplary plant tie band apparatus, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation.

Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

In conventional operations, plant bundles such as herbs and leafy vegetables are typically secured by hand. Workers gather stems or plant bodies into bundles and manually wrap an elastic band, twist tie, or other fastener around the bundle. This process is labor intensive, time consuming, and may produce inconsistent bundle quality. Various tying systems have been developed, but they often rely on complex pathways for feeding the tie material around the plant bundle or require frequent maintenance and adjustment to accommodate different plant sizes and types. Further, existing systems are often insufficiently robust for continued operation in field conditions or across varied processing contexts, leading to downtime, tie misfeeds, or incomplete bundle formation.

Accordingly, there remains a need for improved systems and apparatus for efficiently and consistently forming tie bands around plant bundles. There is a particular need for configurations that automate the tying process while reducing component complexity, improving reliability, and increasing throughput across varying agricultural environments.

Therefore, described herein are systems and apparatus for automatically applying tie bands around plant bundles. In various embodiments, the systems include a plant tie band apparatus configured to receive a plant bundle, form a tie band around the bundle, and eject the tied bundle for further handling or processing. For example, the apparatus may include an assembly that feeds a tie through a tie channel and twists the tie to secure the plant bundle, or a gear-based tying assembly that wraps a tie around the bundle without the need to feed and retain the tie within a tie channel. These systems may further incorporate sensors, cutters, and automated control elements to facilitate reliable, high-speed operation in both field and processing applications.

The plant tie band apparatus disclosed herein may be configured to tie a tie band around any suitable plant bundle including, but not limited to, herbs and leafy vegetables including, for example, cilantro, coriander, basil, kale, and spinach, as well as other vegetables such as, for example, carrots, green onions, radishes, beets, asparagus, broccoli, cauliflower, and green beans.

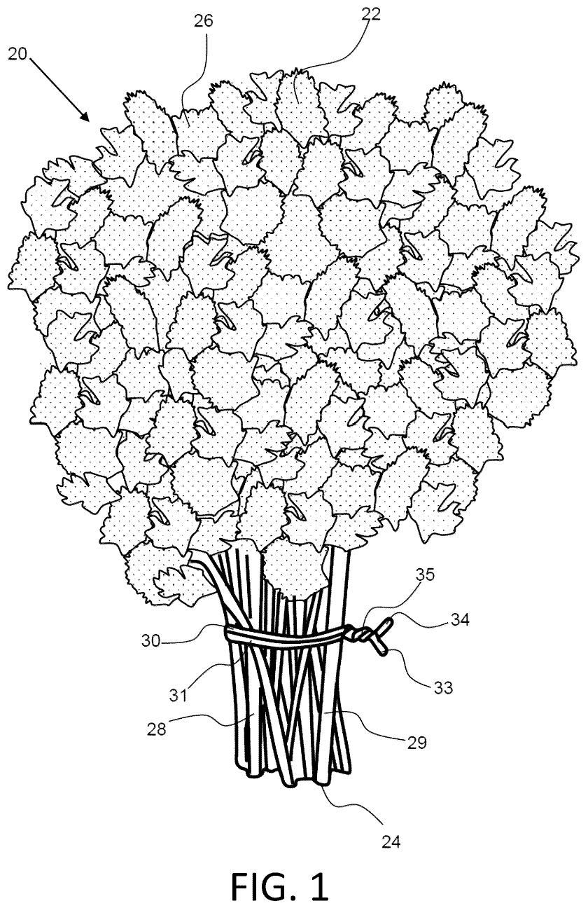

In various embodiments, and with reference to FIG. 1, a plant bundle 20 is shown having a plant end 22 and a stem end 24. The plant end 22 may comprise leaves 26 or foliage of the plant, and the stem end 24 of the plant bundle 20 may include a plurality of stems 29 that may collectively form a stem bundle 28. The plant bundle 20 may be configured from any suitable plant type.

In various embodiments, a tie 30 may be configured around the plant bundle 20, such as around the stem bundle 28, to form a tie band 31. However, the tie 30 may be configured to form a tie band 31 around any suitable portion of the plant bundle 20, depending on the plant. As a non-limiting example, the tie 30 may be configured to form a tie band 31 around the midway point of a bundle of carrots, celery stalks, or other elongated vegetables without suitably robust stem structures.

The tie 30 may comprise, for example, a rigid portion, such as a wire, stiff polymer filament, plastic rod, bead, or any other suitable material configured to provide sufficient stiffness to enable the tie 30 to be pulled, pushed, or otherwise manipulated. For example, in various embodiments, the rigid portion of the tie 30 may be formed from a malleable metal or plastic that retains a twisted configuration once cinched around the plant bundle 20, although the present disclosure is not limited in this regard.

In various embodiments, the tie 30 may include one or ore more flange portions extending outwardly from the rigid portion in generally opposing directions. The flange portions may be formed from a flexible or non-woven material, such as plastic film, paper, or other suitable sheet material. The flanges may be configured to flex or deform as the tie 30 is pulled around the plant bundle 20, allowing the tie 30 to pass through confined or narrow openings of a plant tie band apparatus while maintaining engagement within a channel, guide pathway, or any other tie routing mechanism thereof. In various embodiments, for example, the tie 30 may comprise a twist tie having a metal rigid portion and deformable flanges extending outwardly therefrom.

In various embodiments, the tie 30 may include a feed end 33 and a trailing end 34, which may collectively define the opposite ends of the tie length. The feed end 33 may represent the portion of the tie 30 initially advanced or guided around the plant bundle 20, while the trailing end 34 may remain coupled to the tie source, such as a tie spool, until the trailing end 34 is severed from the tie source. In various alternative embodiments, the tie 30 may be provided in a predetermined length suitable for tying around a plant bundle 20 without severing the tie 30 from a tie source. Once the feed end 33 has been advanced around the plant bundle 20, the feed end 33 and the trailing end 34 may be engaged and twisted together to form a twisted portion 35 of the tie 30. The twisting action may pull the tie 30 to be in contact with the plant bundle 20, cinching the tie 30 into a closed loop around the plant bundle 20, thereby forming a tie band 31. The twisted portion 35 may be configured to retain its deformed shape after twisting, thereby maintaining tension and contact around the plant bundle 20 during handling, processing, and storage. In various embodiments, the tension created by the formation of the tie band 31 around the plant bundle 20 may be altered or configured depending on the characteristics of the plant bundle 20, such as the quantity and/or variety of plants in the plant bundle 20.

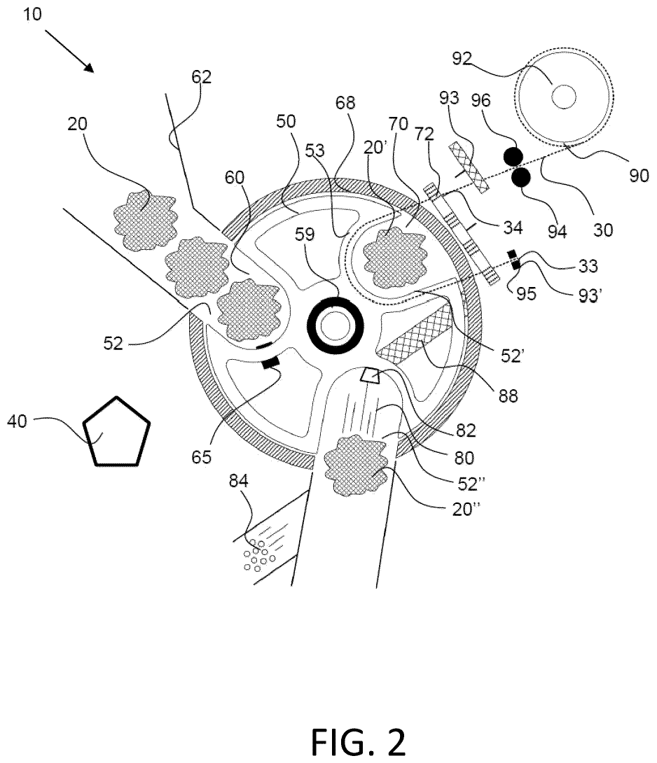

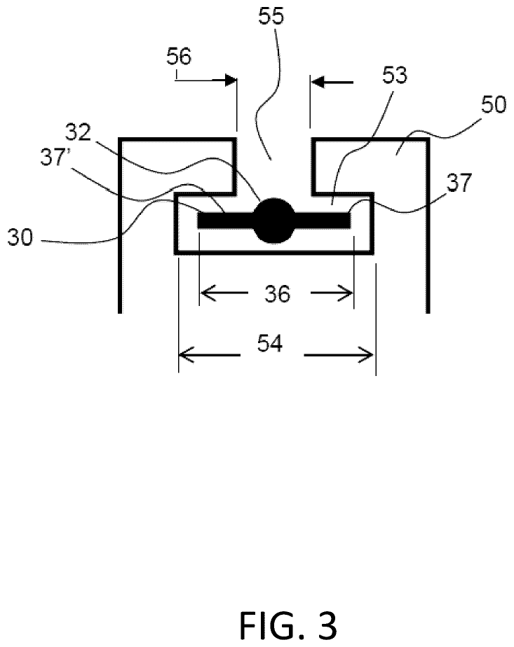

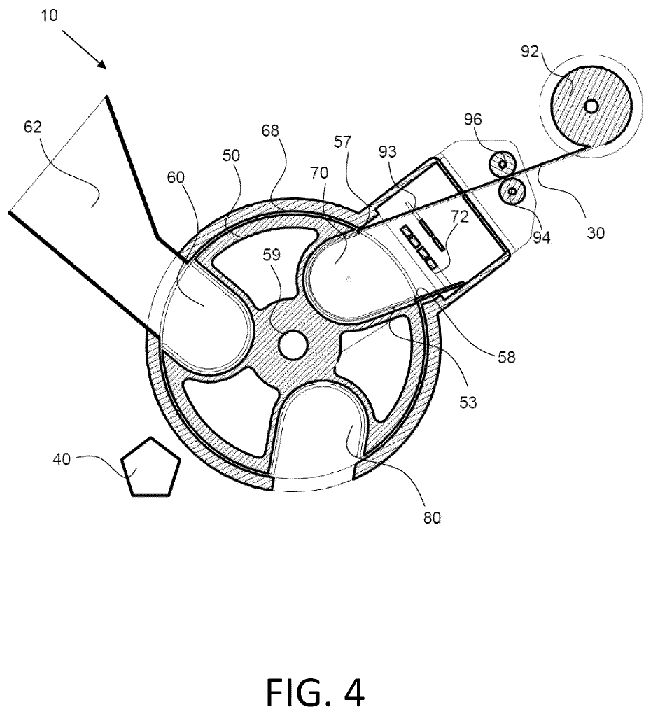

In various embodiments, and with additional reference to FIGS. 2-4, a plant tie band apparatus 10 is disclosed herein. The apparatus 10 may be configured to automatically form a plant tie band 31 around a plant bundle 20 to create a compact, secured bundle suitable for packaging or further handling. The apparatus 10 may generally comprise a processing wheel 50 having a plurality of plant receivers 52 spaced circumferentially apart around the processing wheel 50 and configured to receive and retain plant bundles 20 during operation. In various embodiments, the processing wheel 50 may be configured to rotate about a hub 59 to sequentially position each plant receiver 52 into a series of processing stations which may include, for example, a plant receiver station 60, a tie station 70, and an eject station 80.

In various embodiments, while positioned within the plant receiver station 60—which may be the first station in the series of processing stations of the apparatus 10—the plant receiver is referred to herein as plant receiver 52. In various embodiments, upon repositioning of the plant receiver 52 to the tie station 70 and/or the eject station 80—which may comprise the second and third processing stations of the apparatus 10, respectively—the plant receiver 52 is referred to herein as plant receiver 52′ or 52″, to convey the sequential positioning of the plant receiver within the first (52), second (52′), or third (52″) processing station. Likewise, the plant bundle 20 retained or positioned within the plant receiver 52 may be similarly denoted to convey the sequential positioning of the plant bundle 20 within the first (20), second (20′), or third (20″) processing station.

In various embodiments, the processing wheel 50 may comprise additional stations, such as a cleaning station, an alignment station, and/or an inspection station. For example, a cleaning station may be positioned between the plant receiver station 60 and the tie station 70 to remove debris from the plant bundle 20 prior to securing the tie band 31 around the plant bundle 20. As another example, an alignment station may likewise, or alternatively, be sequentially positioned prior to the tie station 70 to ensure that the plant bundle 20 is sufficiently aligned to ensure proper tie band 31 placement. As a further example, an inspection station may be sequentially positioned following the tie station 70 to ensure that the tie band 31 is properly configured around the plant bundle 20. However, various alternative or additional stations suitable for agricultural or processing applications of the apparatus 10 may be included, such as those configured for trimming, sorting, cutting, weighing, or packaging of the plant bundle 20.

In various embodiments, the processing wheel 50 may rotate continuously or in indexed steps to move each plant receiver 52 through the stations in sequence. The rotation may be driven by an electric or mechanical drive assembly controlled by a controller 40, which may be configured to coordinate operation of the processing wheel 50 with other components of the apparatus 10. Each plant receiver 52 may be configured to securely hold a plant bundle 20 during rotation, for example by including curved or contoured walls or guides shaped to correspond to the profile of the plant bundle 20. To prevent the bundle 20 from falling or shifting during rotation, a retainer drum 68 may extend around a portion of the processing wheel 50, with openings provided at each of the stations to allow insertion, tying, and ejection of the bundles 20 while ensuring the plant bundles 20 are retained within the apparatus 10 during rotation.

At the plant receiver station 60, a plant funnel 62 may be positioned to guide plant bundles 20 into the plant receivers 52 disposed within the station 60. A plant sensor 65 may be disposed proximate the plant receiver 52 to detect the presence of a plant bundle 20. In various embodiments, the plant sensor 65 may comprise one or more sensing elements configured to detect the presence or absence of a plant bundle 20, such as optical, infrared, ultrasonic, capacitive, or mechanical sensors.

Upon the plant sensor 65 detecting the presence or absence of a plant bundle 20, the plant sensor 65 may transmit a signal to the controller 40. In various embodiments, the signal may be transmitted from the plant sensor 65 via a wired connection or a wireless protocol suitable for industrial control applications. Upon receiving the signal, the controller 40 may inhibit or delay the feeding of a tie 30 until a plant bundle 20 is properly detected within the receiver 52, thereby reducing the likelihood of tie misfeeds or mechanical malfunction of the apparatus 10 during subsequent process steps. In some embodiments, additional guides or alignment components may be provided to orient the bundle 20 within the receiver 52 for optimal tie 30 placement during subsequent processing.

In various embodiments, the processing wheel 50 may then advance the plant receiver 52′ to the tie station 70, wherein the tie 30 may be applied around the plant bundle 20′ to form a tie band 31. In various embodiments, the tie station 70 may comprise a tie feeder 94 configured to feed a tie 30 from a tie spool 92 through a tie guide 93 and into a tie channel 53 defined within the processing wheel 50. The tie channel 53 may extend partially or fully around the circumference of the plant receiver 52′, such that the tie 30 may be guided around the plant bundle 20′ situated therein. The tie 30 may be advanced throughout the tie channel 53 by the tie feeder 94, which may include a pair of tie feeder rollers 96 or other drive elements that are configured to frictionally engage and push the tie 30 through the tie guide 93 and into a tie channel inlet 57.

In various embodiments, the tie 30 may comprise a rigid portion 32 configured to provide sufficient stiffness to enable the tie 30 to be advanced through a guide or channel without significant deformation. In various embodiments, the rigid portion 32 may include a wire, rod, filament, or other elongated member formed from a metal, polymer, or composite material that exhibits both rigidity and controlled malleability. In various embodiments, the tie 30 may further comprise one or more flange portions 37, 37′ extending laterally from the rigid portion 32 in generally opposing directions. The flange portions 37, 37′ may be formed from a flexible or semi-flexible material, for example a plastic film, paper, or nonwoven sheet. The flange portions 37, 37′ may act as retention elements that prevent the tie 30 from passing completely through a narrow guide, such as an opening 55 of the tie channel 53, while still allowing the tie 30 to flex and conform as it is pulled or twisted.

In various embodiments, the tie 30 may have a width 36 that is less than a width 54 of the tie channel 53 or feed path through which the tie is advanced, but greater than the width 56 of a tie channel opening 55, which may be disposed radially inward toward the plant receiver 52. For example, the tie width 36 may exceed the opening width 56 by about 20%, 25%, 30%, 35%, 40%, 45%, 50%, or any width suitable to provide frictional retention of the tie 30 during feeding. This dimensional relationship may allow the tie 30 to remain supported and guided through the tie channel 53 or feed path while still being capable of withdrawal when the tie 30 is twisted or tensioned.

In various embodiments, the tie channel 53 may terminate at a tie channel outlet 58 which may be positioned opposite the tie channel inlet 57, allowing the feed end 33 of the tie 30 to emerge after traveling through the tie channel 53. In various embodiments, a tie sensor 95 may be configured to detect the presence of the feed end 33 of the tie 30 at the tie channel outlet 58 to confirm that the tie 30 has been successfully indexed through the tie channel 53. In various embodiments, the tie sensor 95 may comprise one or more sensing elements configured to detect the presence or absence of the feed end 33 of the tie 30, such as optical, infrared, ultrasonic, capacitive, or mechanical sensors. In various embodiments, the feed end 33 of the tie 30 may emerge through an additional tie guide 93′ configured to route the tie 30 to a suitable position for detection by the tie sensor 95.

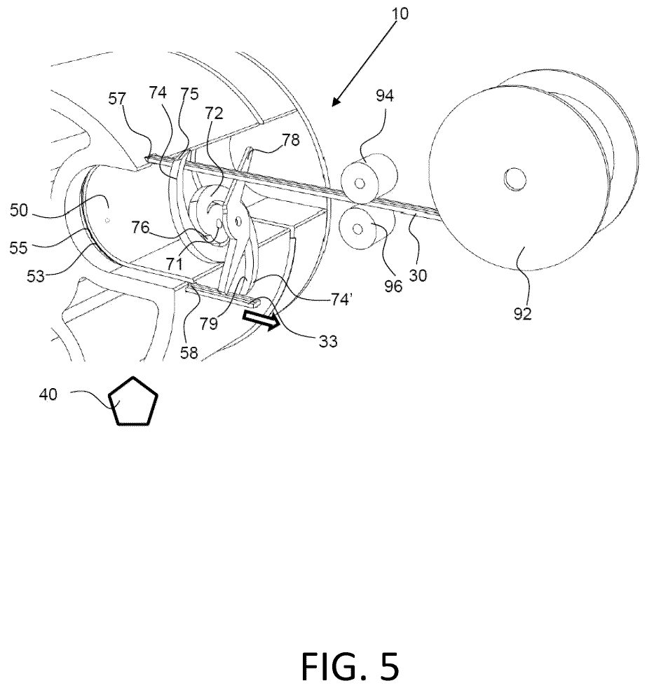

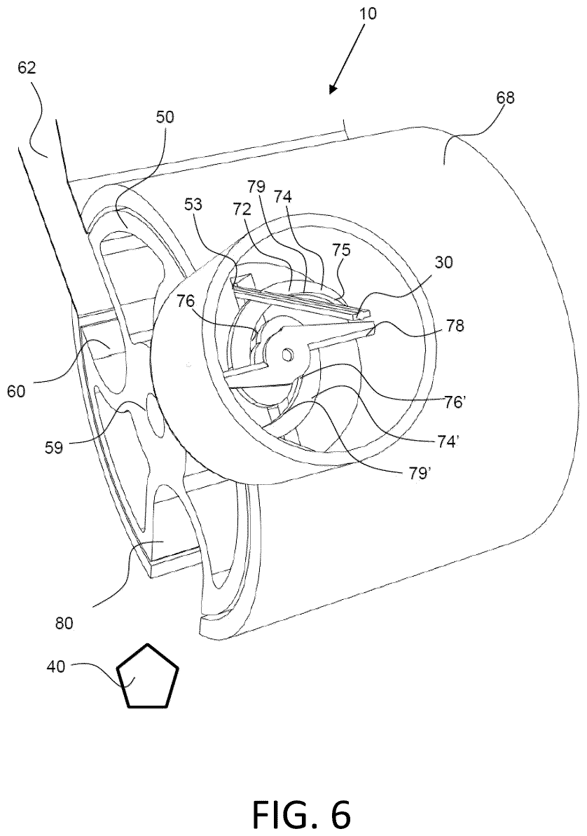

Once the tie 30 has been fully fed through the tie channel 53 in accordance with various embodiments, and with additional reference to FIGS. 5 and 6, a tie cutter 78 may be configured to sever the tie 30 from the spool 92, creating a trailing end 34. In various embodiments, the tie cutter 78 may be configured to delay severing the tie 30 from the spool 92 until during or after subsequent twisting processes.

A tie rotor 72 may be located at the tie station 70 and may comprise a pair of tie rotor arms 74, 74′, which may be configured to engage the tie 30 near the feed end 33 and trailing end 34. The tie rotor arms 74, 74′ may rotate simultaneously to twist the engaged tie 30 around the plant bundle 20', forming the twisted portion 35 of the tie band 31. Each tie rotor arm 74, 74′ may include a curved interface surface 79, 79′ extending inwardly from an extended end 75, 75′ of each tie rotor arm 74, 74', wherein the curved interface surface 79, 79′ guides the tie 30 into a tie retainer channel 76, 76′ configured to maintain engagement with the tie 30 during twisting. The interface surfaces 79, 79′ and the retainer channels 76, 76′ may spiral inward toward a rotational hub 71 of the tie rotor 72, facilitating symmetrical twisting about the plant bundle 20′.

In various embodiments, the tie rotor 72 may be driven by a twisting motor or rotary actuator coupled to the hub 71 of the tie rotor 72, configured to deliver rotational torque for the twisting operation. The twisting motor may be mounted to a frame or support structure adjacent the tie station 70, and may be controlled by the controller 40 or an independent motor controller. In various embodiments, the use of a dedicated twisting motor may provide precise control over rotational speed and torque, allowing the twisting process to be optimized for different tie materials, such as wires, films, or compositions. In some embodiments, the twisting motor may share a power or control circuit with a drive motor of the processing wheel 50, enabling synchronized movement between the twisting and rotational operations of the apparatus.

In various embodiments, as the tie 30 is twisted, the frictional and tensile forces generated therefrom cause the tie 30 to be withdrawn radially inward from the tie channel 53 through the tie channel opening 55 and toward the bundle 20', thereby cinching the tie 30 around the plant bundle 20 to form a secured tie band 31. In various embodiments, the twisting and cutting operations may be timed or synchronized by controller 40 based on sensor feedback or preset operating sequences. The tied plant bundle 20′ may then be advanced by the processing wheel 50 to the eject station 80, where the bundle 20″ is released or expelled from the apparatus 10.

In various embodiments, once the bundle 20″ secured with a tie band 31 is advanced to the eject station 80, the plant receiver 52″ may be oriented downward to facilitate release of the tied plant bundle 20″ by gravity. In certain embodiments, an eject device 82, such as a directed stream of air, a mechanical pushing device, or any suitable ejection means, may assist in dislodging the bundle 20″ from the receiver 52″. In various embodiments, a debris chute 84 may be positioned to collect plant debris or fragments during ejection. In various embodiments, a stem cutter 88, such as a fixed cutter, may be mounted adjacent the eject station 80 to trim the stems 29 of the plant bundle 20′ as it is rotated or advanced from the tie station 70 to the eject station 80, providing a clean, uniform cut prior to ejection.

In various embodiments of the apparatus 10, the controller 40 may coordinate the operation of the plant sensor 65, tie sensor 95, tie feeder 94, tie cutter 78, tie rotor 72, eject device 82, and/or stem cutter 88. In various embodiments, the controller 40 may interface with one or more feedback sensors positioned at the twisting motor or processing wheel 50 to monitor rotational speed and torque. The controller 40 may be configured to store or execute preset operating sequences, adjust tying parameters dynamically based on plant type or bundle size, and record the number of plant bundles 20 processed. In various embodiments, the apparatus 10 may include an automated plant bundle feeder or conveyor configured to supply plant bundles 20 to the receiving station 60, allowing continuous or semi-continuous operation of the apparatus 10.

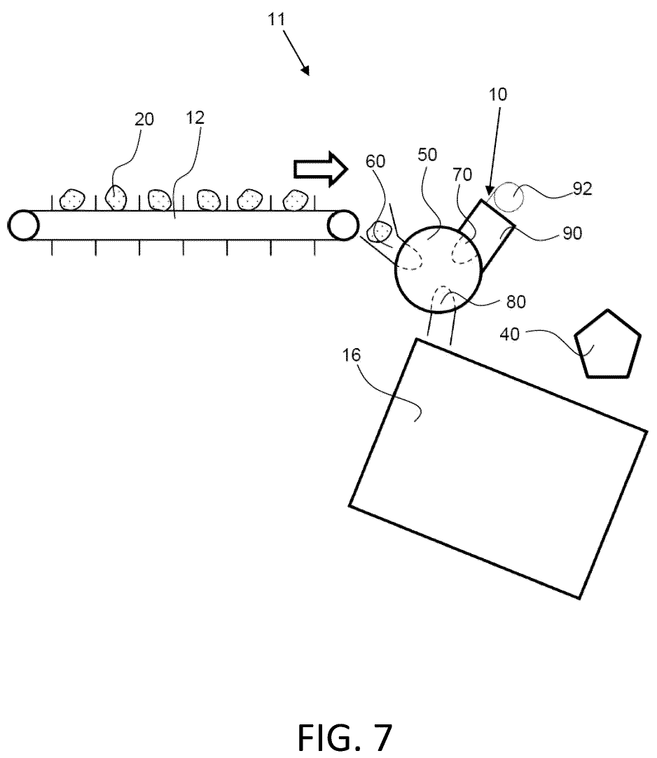

In various embodiments, and with reference to FIG. 7, a plant bundle processing system 11 is shown. In various embodiments, the system 11 may comprise a plant tie band apparatus 10 integrated within a larger automated assembly for receiving, tying, and discharging plant bundles 20. In various embodiments, a plant feeder 12, such as a belt or conveyor system, may be configured to deliver individual plant bundles 20 toward the plant receiver station 60 of the processing wheel 50 of the plant tie band apparatus 10. In various embodiments, the processing wheel 50 may be configured to advance each bundle 20 sequentially through the tie station 70 and the eject station 80, where a tied bundle 20″ is ultimately released. In various embodiments, a tie indexing system 90 supplies and advances a tie 30 from a tie spool 92, while a controller 40 coordinates the operation of the various stations, sensors, and drive mechanisms.

In various embodiments of the system 11, tied plant bundles 20″ exiting the eject station 80 may be received within a receiver bin 16 or transferred along a secondary conveyor for additional handling, such as trimming, inspection, or packaging. The system 11 may be configured for stationary installation in a processing facility or mounted on a mobile platform for in-field operation. In either configuration, however, the system 11 enables continuous or semi-continuous processing of harvested plants by automating the bundling and tying operations, thereby reducing manual labor while improving throughput and consistency of bundle formation.

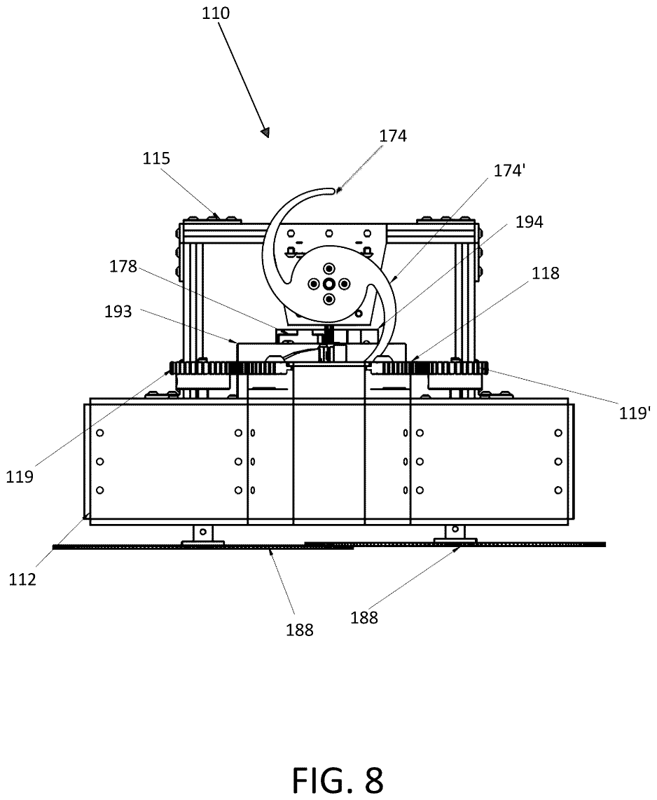

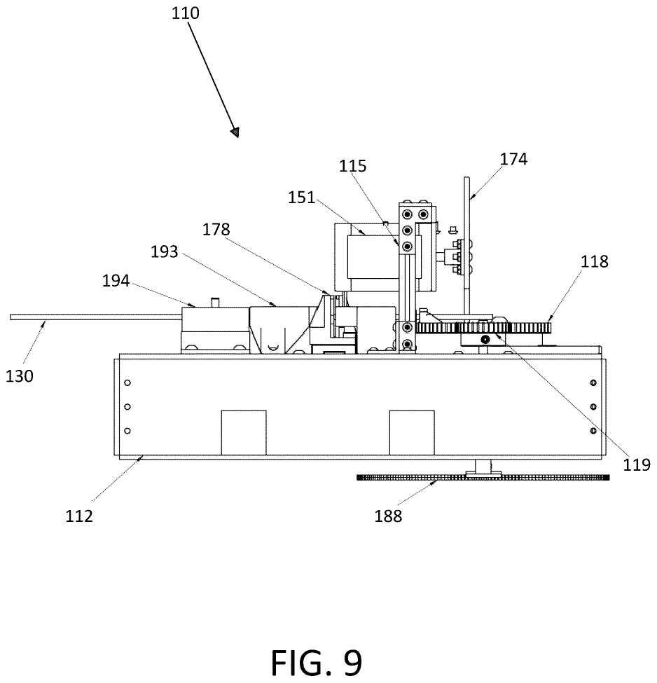

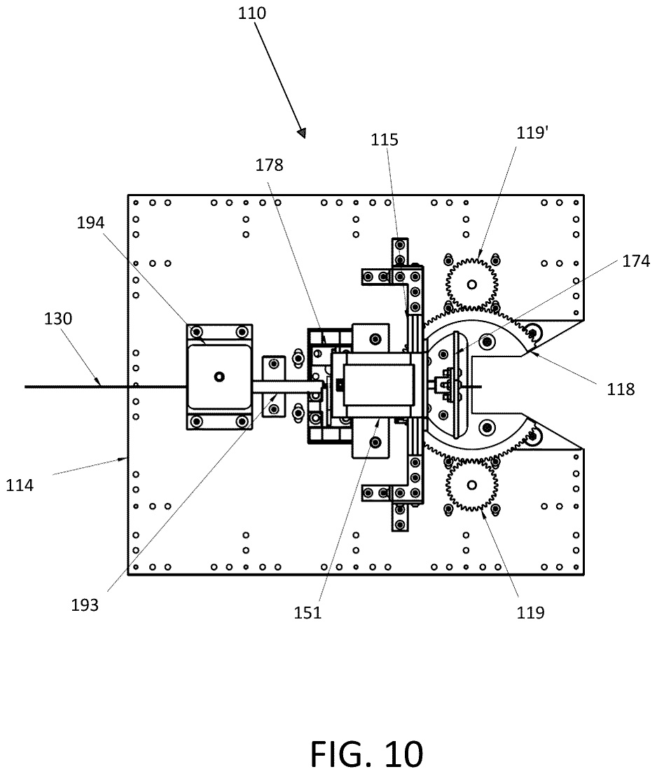

In various embodiments, alternative plant tie band apparatus configurations may be employed to achieve the same general function of forming a tie band around a plant bundle while simplifying the mechanical structure and eliminating the need for a tie channel, potentially improving operational efficiency. For example, in certain embodiments described in FIGS. 8-10, a plant tie band apparatus 110 is provided that incorporates a gear-based tying assembly configured to wrap a tie 130 around a plant bundle without requiring the tie 130 to pass through a circumferential channel. The apparatus 110 may share control and coordination features, tie feeding principles, and twisting and cutting functions analogous or substantially similar to those described in relation to the apparatus 10, but through a more compact and modular assembly particularly suitable for in-field use. However, it should be understood that the gear-based tying assembly disclosed herein may be compatible with various components of the apparatus 10.

In various embodiments, and with continued reference to FIGS. 8-10, a plant tie band apparatus 110 is disclosed herein. The apparatus 110 may be configured to automatically form a tie band around a plant bundle using a tie 130, which may be fed, twisted, and cut to secure the bundle without requiring the tie 130 to pass through a tie channel. The apparatus 110 may be implemented as a stand-alone unit or integrated within a larger processing system such as system 11 described herein.

In various embodiments, the apparatus 110 may include a frame 112 configured to support and house the operational components of the apparatus 110. The frame 112 may include a mounting plate 114 forming a top surface upon which the active mechanical assemblies are mounted, and a lower portion that may support one or more plant stem cutters 188 or equivalent trimming mechanisms. The mounting plate 114 may provide structural rigidity and alignment for the feed, twisting, and cutting components, and frame 112 may be formed of a corrosion-resistant metal or polymer suitable for agricultural or food-processing purposes.

In various embodiments, the tie 130 may be supplied from a spool or reel positioned adjacent to or beneath the mounting plate 114. The tie 130 may then be advanced by a tie feeder 194, which may include rollers, belts, or other advancing elements configured to frictionally interact with and advance the tie 130 at a controlled rate. The tie 130 may then be directed by a tie guide 193 that aligns and positions the tie 130 along a feed path extending toward the tying and twisting region of the apparatus 110.

In various embodiments, downstream of the tie guide 193, a tie cutter 178 may be disposed along the feed path. The cutter 178 may be operable between an open position—allowing the tie 130 to pass through freely—and a closed position in which a blade or shear severs the tie 130 after a tying cycle is completed, or otherwise after the tie 130 has been fed through the apparatus 110 to a suitable position for subsequent processing.

In various embodiments, the tying and twisting operation of the apparatus 110 may comprise a main gear 118, which may be mounted atop the mounting plate 114 and supported for rotational movement. The main gear 118 may be driven through interaction with one or more driving gears 119, 119′, which may be positioned on opposite sides of the main gear 118. In various embodiments, the driving gears 119, 119′ may be powered by one or more motors under control of a controller, and may engage the outer periphery of the main gear 118 to impart rotational motion.

In certain embodiments, the main gear 118 defines an arcuate body having a partial circumference including an open portion configured to allow entry of a plant bundle radially inward of the main gear 118 to a plant receiver disposed therein and configured to receive the plant bundle. The open portion may represent, for example, approximately 20% to 50% of the outer circumference of the main gear 118, although the present disclosure is not limited in this regard.

In various embodiments, the main gear 118 may further comprise a receiving arm or other suitable means extending axially upward from the outer periphery of the main gear 118. For example, the receiving arm may include a clamp or hook mechanism configured to engage the leading or feed portion of the tie 130 as it is fed from the tie feeder 194. When the apparatus 110 is in a first position, the receiving arm may be aligned with the tie guide 193 such that the tie guide 193 is configured to direct the tie 130 to be received and retained by the receiving arm, while the open portion of the main gear 118 is simultaneously positioned to allow the insertion of a plant bundle into the plant receiver. In various embodiments, the plant bundle may be inserted into any suitable location within the plant receiver situated radially inward from the receiving arm of the main gear 118, such that subsequent rotation of the main gear 118 from the first position is not interfered with by the plant bundle. In various embodiments, the plant bundle may be positioned manually, automatically, or through a guide mechanism situated within the plant receiver to sufficiently align the bundle.

In various embodiments, once the bundle is positioned, one or both driving gears 119, 119′ are actuated to rotate the main gear 118 about a center axis. As the main gear 118 turns, the receiving arm moves the leading portion of the tie 130 around the plant bundle. In various embodiments, because the main gear 118 includes an open portion, the engagement of the driving gears 119, 119′ may alternate or overlap such that one disengages when the other engages to ensure continued motion of the main gear 118 during rotation. Stated otherwise, the driving gears 119, 119′ may be oriented such that, despite the open segment of the main gear 118, during actuation, at least one of the driving gears 119, 119′ remains engaged with the main gear 118. As the main gear 118 continues to rotate about the center axis, the tie 130 may be drawn substantially around the plant bundle.

In various embodiments, following rotating, the main gear 118 may reach a second position wherein the leading and trailing portions of the tie 130 are suitably positioned for engagement by a rotor for twisting and tying. In the second position, the open portion of the main gear 118 may be positioned such that the plant bundle disposed within the plant receiver may be retained within the tying station during subsequent tying processes. In various embodiments, a rotor motor 151, which may be mounted on a mounting frame 115 coupled to the mounting plate 114, may then actuate to rotate one or more rotor arms 174, 174′ positioned proximate the converging ends of the tie 130. The rotor arms 174, 174′ may be configured to capture and rotate the tie 130 ends to form a twisted portion, thereby tightening and securing the tie 130 around the stems of the bundle. The number of rotations or torque applied by the rotor motor 152 may be predetermined or controlled dynamically by a controller to achieve a desired tie band tension.

In various embodiments, during or after the twisting operation, the tie cutter 178 may transition to its cutting position, severing the tie 130 to release the tied bundle thereby secured with a tie band. In various embodiments, releasing the tied bundle may further comprise the main gear 118 actuating from the second position back to the first position, rendering the tying station amenable for subsequent tying processes. The bundle may then be discharged from the apparatus 110 or advanced to a subsequent trimming stage. For example, in certain embodiments, one or more plant stem cutters 188 positioned below the mounting plate 114 may operate concurrently to trim the stem ends of the tied bundle as it is released, producing a clean and uniform appearance.

In various embodiments, the apparatus 110 may be modular in construction, allowing the substitution or adjustment of the main gear 118, rotor motor 151, or tie feeder 194 for different plant types or tying materials.

It will be apparent to those skilled in the art that various modifications, combinations, and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote various parts but not necessarily to denote the same or dissimilar materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A plant tie band apparatus, comprising:
a frame; and
a main gear defining an open portion disposed circumferentially around a plant receiver;
wherein, in a first position, the open portion is aligned to allow the plant receiver to receive a plant bundle, and wherein a receiving arm coupled to the main gear is aligned to receive a tie; and
wherein rotation of the main gear from the first position to a second position rotates the receiving arm in a substantially circular path around the plant bundle to position the tie for securing the plant bundle.

2. The apparatus of claim 1, further comprising one or more driving gears positioned to rotate the main gear between the first and second positions.

3. The apparatus of claim 2, wherein the one or more driving gears are driven by a motor.

4. The apparatus of claim 1, further comprising a rotor, the rotor comprising one or more rotor arms to form a tie band around the plant bundle.

5. The apparatus of claim 1, further comprising a tie feeder.

6. The apparatus of claim 5, further comprising a tie guide positioned along a feed path between the tie feeder and the receiving arm.

7. The apparatus of claim 6, further comprising a tie cutter.

8. The apparatus of claim 1, further comprising a hub configured to support one or more plant receivers and to rotate the one or more plant receivers between a plurality of stations.

9. The apparatus of claim 8, wherein the plurality of stations comprises a plant receiver station, a tying station at which the main gear is positioned, and an eject station at which the plant bundle is released from the apparatus.

10. The apparatus of claim 1, further comprising a plant stem cutter coupled to the frame.

11. The apparatus of claim 10, wherein the plant stem cutter comprises one or more blades positioned beneath the frame.

12. The apparatus of claim 1, wherein the open portion of the main gear may comprise from between about 20% and about 50% of a circumference of the main gear.

13. The apparatus of claim 1, further comprising a controller to coordinate operation of the main gear.

14. A plant tie band apparatus, comprising:
a main gear defining an open portion disposed circumferentially around a plant receiver, the main gear having a receiving arm coupled thereto to receive a tie in a first position of the main gear;
a rotor having one or more rotor arms to form a tie band around the plant bundle; and
a controller to coordinate rotation of the main gear and operation of the rotor.

15. The apparatus of claim 14, wherein the controller actuates the rotor when the main gear reaches a second position.

16. A plant bundle processing system, comprising:
a plant receiver station configured to receive a plant bundle;
a tying station comprising a main gear defining an open portion disposed circumferentially around a plant receiver to receive the plant bundle, a receiving arm coupled to the main gear and configured to receive a tie in a first position of the main gear, and a rotor to form a tie band around the plant bundle; and
an eject station configured to discharge the plant bundle after formation of the tie band.

17. The system of claim 16, further comprising a sensor positioned at the plant receiver station.

18. The system of claim 16, further comprising a plant stem cutter positioned between the tying station and the eject station.

19. The system of claim 18, further comprising a controller to operate at least one of the receiver station, the tying station, the stem cutter, and the eject station.

20. The system of claim 16, wherein the eject station comprises an eject device comprising one or more of an air jet or a mechanical ejector.
